(19) United States
(12) Patent Application Publication
(10) Pub. No.: US 2006/0257533 A1
(43) Pub. Date: Nov. 16, 2006

(54) Self-venting reclosable packages

(76) Inventors: Eric Paul Plourde, Homewood, IL (US); Michael Lasofsky, Pomona, NY (US)

Correspondence Address: Dennis M. Flaherty, Esq.;Ostrager Chong Flaherty & Broitman P.C., 250 Park Avenue, Suite 825, New York, NY, 10177-0899, US

(21) Appl. No.: 11/127,879

(22) Filed: May 12, 2005

(51) Int. Cl. A23B 7/148

(52) U.S. Cl. 426/106

(57) ABSTRACT

Reclosable packages containing food product that can be exposed to cooking temperatures without rupture of the product compartment. The various disclosed embodiments have the following common features: means for forming a first interior volume that is hermetically sealed, at least a portion of the first interior volume containing product; means for forming a second interior volume that is in fluid communication with the exterior of the package via a vent hole and is not in fluid communication with the first interior volume; and frangible means designed to rupture when the pressure inside the first interior volume increases to a predetermined level during cooking. The second interior volume will be in fluid communication with the first interior volume as a result of rupture of the frangible means.

### BACKGROUND OF THE INVENTION

The present invention generally relates to sealed packages having means for venting gas from the product compartment to the outside when the product (typically food) is heated.

In many consumer packaging applications, it is important to prevent air or water or the like from passing out of or into a package containing certain perishable products, such as meat packages, cheese packages, and the like, for which the contained product must be kept in a constant environment to prevent spoilage. To preserve the contained product, the periphery of the package must be hermetically sealed. Hermetic seals can be provided by both permanent seals and temporary seals known as peel seals. A reclosable package typically comprises a receptacle having permanent seals at its sides and bottom and a peelable seal above or below a closure installed in the mouth of the receptacle. The closure typically comprises a pair of zipper strips made from extruded thermoplastic material and having mutually interlockable closure profiles.

Peelable seals can provide a hermetic seal and, at the same time, providing a consumer with easy access to the contents of a package. Typically, the consumer breaks the peel seal by grasping opposing walls of the receptacle or opposing pull flanges of the closure and then pulling the walls or flanges apart. The peel seal may be formed by adhering a layer of peelable seal material to opposing portions of the package, such as portions of opposing walls of the receptacle, opposing pull flanges of the closure or of opposing extension flanges of the closure to which the receptacle walls are permanently sealed.

Typically one or more sealing stations are used to seal three sides of the receptacle, to join both sides of the closure to the mouth of the package and to activate a strip of peel sealable materials to make the peel seal. Each sealing station comprises a pair of reciprocatable sealing bars, at least one of which is heated. When the sealing bars are extended, they apply heat and pressure to the materials to be sealed or activated. The strength of the seals is determined by the temperature, pressure, and dwell time of the sealing bars. The strength of the seals is also, in a large part, determined by the material being sealed. At the same temperature/pressure/dwell time, a peelable material will still peel, while other sealant materials will create a permanent seal. Many peel seal materials have a “flat” peel strength curve, i.e., above a certain threshold, increasing temperature/pressure/dwell time does not increase the peel force.

In some applications, however, rather than preventing the escape of gas from the interior volume of a package, the venting of gas under certain circumstances is desired. For example, it is known (see, e.g., U.S. Pat. No. 6,066,346) to provide a peel seal in a microwavable flexible package containing popcorn kernels. The peel seal is designed to rupture during microwave cooking, thereby allowing hot gases to vent from the interior volume of the package to the outside. The portions of the peel seal that do not rupture can be physically separated after microwave cooking for ease of access to the popped corn.

Flexible packaging that allows food to be heated in the package is becoming more prevalent. There is a need to design flexible packages for food that are initially hermetically sealed, that vent gases during cooking, and that are reclosable after opening.

### BRIEF DESCRIPTION OF THE INVENTION

The present invention is directed to reclosable packages that have a sacrificial frangible barrier that, when intact, hermetically seals a product compartment. The sacrificial barrier is designed to rupture when a predetermined pressure level is reached inside the product compartment during cooking. The rupture of the sacrificial barrier relieves the pressure buildup, thereby avoiding rupture of the product compartment during cooking.

One aspect of the invention is a package comprising: means for forming a first interior volume that is hermetically sealed, at least a portion of the first interior volume containing product; means for forming a second interior volume that is in fluid communication with the exterior of the package via a vent hole and is not in fluid communication with the first interior volume; and frangible means designed to rupture when the pressure inside the first interior volume increases to a predetermined level during cooking, the second interior volume will be in fluid communication with the first interior volume as a result of rupture of the frangible means.

Another aspect of the invention is a package comprising: a receptacle construction having surfaces that bound an interior volume; a fastener comprising first and second closure profiles that are mutually interengageable and disposed within the interior volume; a peel seal joined to the receptacle construction; a barrier web comprising a first portion that hermetically seals a first portion of the interior volume of the receptacle construction, the barrier web comprising a second portion joined to one side of the peel seal and connected to the first portion of the barrier web; food product contained in the hermetically sealed first portion of the interior volume of the receptacle construction; and a vent hole that allows fluid communication between a second portion of the interior volume of the receptacle construction not hermetically sealed by the barrier and the exterior of the package, wherein the peel seal is designed to rupture when the pressure inside the first portion of the interior volume increases to a predetermined level during cooking, the second portion of the interior volume being in fluid communication with the first portion of interior volume as a result of the rupture of the peel seal.

A further aspect of the invention is a package comprising: a receptacle construction having surfaces that bound an interior volume; a peel seal joined to a top portion of the receptacle construction in a manner that hermetically seals the interior volume, the peel seal being designed to burst when the pressure inside the interior volume reaches a predetermined level during cooking; a fastener comprising first and second closure profiles that are mutually interengageable and disposed within the interior volume, the fastener partitioning the interior volume into a product compartment and a header compartment when the first and second closure profiles are mutually interengaged, the header compartment being disposed between the fastener and the peel seal, the fastener comprising a vent hole that allows fluid communication between the product and header compartments; and food product contained in the product compartment.

Other aspects of the invention are disclosed and claimed below.

### BRIEF DESCRIPTION OF THE DRAWINGS

FIG. 1 is a schematic showing a sectional view of a reclosable package in accordance with one embodiment of the invention.

FIG. 2 is a drawing showing a fragmentary sectional view of the upper portion of the package depicted in FIG. 1.

FIG. 3 is a schematic showing a sectional view of a reclosable package in accordance with another embodiment of the invention.

FIGS. 4 through 11 are schematics showing respective sectional views of reclosable packages in accordance with other embodiments of the invention.

Reference will now be made to the drawings in which similar elements in different drawings bear the same reference numerals.

### DETAILED DESCRIPTION OF THE INVENTION

Various embodiments of the invention will now be described. Each of the packages described below has front and rear walls made of packaging material, such as bag making film. The front and rear walls are joined together (e.g., by conductive heat sealing) at their respective sides to form left and right side seals. The bottom of the package is typically formed by a fold that connects the front and rear walls, but in the alternative, the front and rear walls may be separate panels heat sealed together along their bottoms to form a bottom seam. In embodiments wherein the front and rear walls extend above the fastener to form a header, the tops of the walls are heat sealed together to form a top seam All top and bottom seams are band-shaped zones of joinder that extend the full width of the package, except for any discontinuity in the top seam for venting purposes.

In each of the embodiments disclosed hereinafter, the fastener structures are formed by the extrusion of thermoplastic material, as a result of which the mutually interlockable profiled closure members of the fastener have a constant profile along their length. The interlockable profiled closure members are herein referred to as “closure profiles”. Respective base webs (or respective portions of a common base web), to which the closure profiles are connected, are joined to the front and rear walls along respective band-shaped zones of joinder. Typically the zones of fastener base web/receptacle wall joinder are formed by conductive heat sealing and extend the full width of the package. To facilitate the joinder of the fastener base webs to the receptacle walls, the base webs (or web) of the fastener structure may have a surface layer of sealant material that melts at a temperature lower than the melting point of the material making up the remainder of the fastener structure.

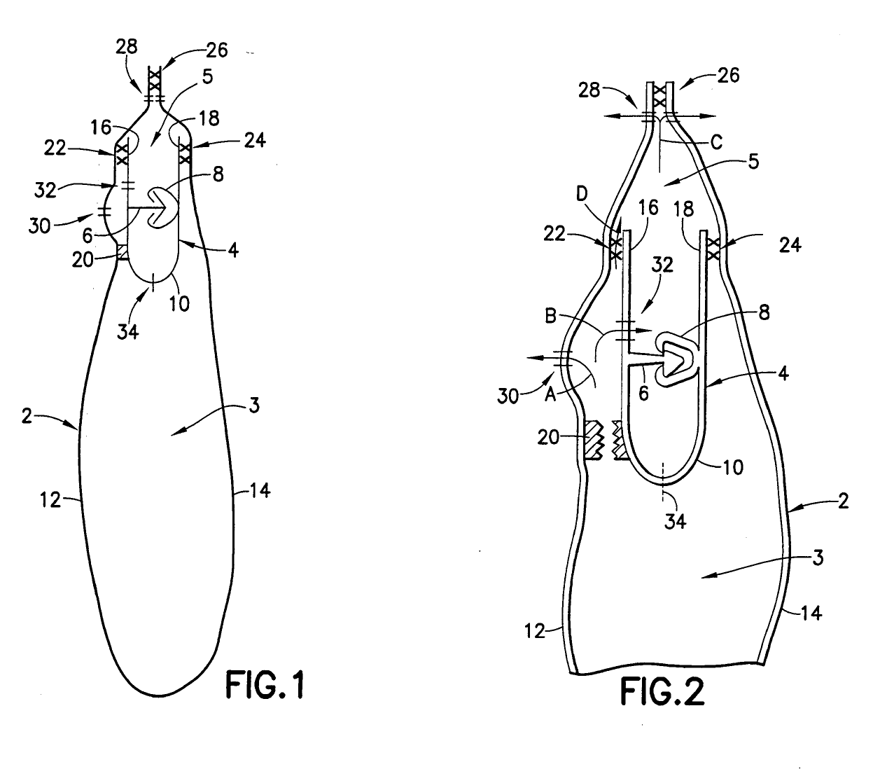

A reclosable package in accordance with a first embodiment of the invention is shown in cross section in FIGS. 1 and 2. The package comprises a receptacle 2 and a flexible plastic structure 4 (described in detail later) disposed inside the receptacle. The receptacle 2 comprises a front wall 12 and a rear wall 14 which are sealed together at parallel side edges (not shown in FIGS. 1 and 2) and are integrally connected by a fold line at the bottom of the receptacle. In an alternative embodiment, the front and rear walls could be sealed together along the bottom as well as the sides. Typically, each side seal is a band-shaped zone of joinder of finite width, forming a side seam.

In accordance with this embodiment, the top marginal portions of the front and rear walls 12 and 14 are joined together to form a top seam 26. Immediately below the top seam 26, the front and rear walls have respective tear lines 28 that facilitate removal of the top seam 26 by tearing along those lines. In accordance with the first embodiment, each tear line 28 comprises a respective series of small holes or micro-perforations arranged at spaced intervals along a line. As will be explained in more detail hereinafter, these small holes or micro-perforations also serve as vent holes for exhausting air from the interior volume of the package to the exterior or ambient atmosphere.

The receptacle 2 may be made from any suitable film material, including thermoplastic film materials such as low-density polyethylene, substantially linear copolymers of ethylene and a C3-C8 alpha-olefin, polypropylene, polyvinylidene chloride, mixtures of two or more of these polymers, or mixtures of one of these polymers with another thermoplastic polymer. The person skilled in the art will recognize that this list of suitable materials is not exhaustive. Although not intended in a limitative sense, it is noted that the thickness of the film is preferably 2 mils or less.

In the embodiment shown in FIG. 1, the structure 4 comprises a folded barrier web 10, a male closure profile 6 connected to and projecting from one side of the folded barrier web 10, and a female closure profile 8 connected to and projecting from the other side of the folded barrier web 10. The male and female closure profiles form a fastener that is closed when the male closure profile 6 is interengaged with the female closure profile 8 and open when the profiles are disengaged. One marginal portion of barrier web 10 is joined to the front wall 12 in a band-shaped zone of joinder 22 (represented by Xs in FIGS. 1 and 2); the opposite marginal portion of barrier web 10 is joined to the rear wall 14 in a band-shaped zone of joinder 24. These zones of joinder are typically formed by conductive heat sealing and extend the full width of the package. The zones of joinder 22 and 24 form permanent seals that are designed to remain intact and not rupture when the package with food product inside is exposed to a medium (e.g., air or water) heated to cooking temperatures. At the sides of the package, the opposing ends of the barrier web 10 are sealed to each other and captured within side seams (not shown) of the receptacle. Also the ends of the closure profiles are thermally crushed and joined together at the side seams.

The package shown in FIG. 1 further comprises a strip of peelable seal material that form a peel seal 20, which extends the full width of the package. One side of the peel seal 20 is joined to the front wall 12, while the other side of the peel seal 20 is joined to one side of the folded barrier web 10. The interior volume of the receptacle 2 is partitioned into a product compartment 3 and a header compartment 5 by the portion of barrier web 10 that extends from the peel seal 20 to the permanent seal 24. Food product (not depicted in FIG. 1) is contained in the product compartment 3. So long as the peel seal 20 remains intact, the peel seal 20, permanent seal 24 and connecting portion of the barrier web 10 form a structure that hermetically seals the product compartment 3.

During cooking, the air pressure inside the hermetically sealed product compartment 3 increases. The peel seal 20 is designed to rupture when the pressure inside the product compartment reaches a predetermined level greater than ambient pressure but less than the pressure at which any other portion of the package would rupture. Thus the peel seal 20 acts as a pressure relief system. The rupture of peel seal 20 is depicted in FIG. 2.

In accordance with the first embodiment, the package depicted in FIGS. 1 and 2 further comprises one or more vent holes for allowing the escape of heated air from inside the package following peel seal rupture. As previously explained, the tear lines 28 comprise small holes or perforations. In addition, one or more vent holes may be formed in the barrier web 10 in the portion thereof that extends upward from the male closure profile 6 and is joined to the front wall 12 at permanent seal 22. One such vent hole 32 is indicated in FIG. 1. More than one such vent hole 32 can be provided in the barrier web 10. [In the case where the barrier web 10 has a vent hole 32, the front wall need not have a vent hole 30, which is also depicted in FIG. 1. Vent holes 30 and 32 are preferably provided in the alternative, although they could be used in conjunction with each other. However, for purposes of discussing the first embodiment, vent hole 30 should be disregarded.]

Still discussing the first embodiment, but now referring to FIG. 2, heated air escaping from the product compartment 3 upon rupture of peel seal 20 will flow through vent hole 32 (which flow is indicated by arrow B in FIG. 2) and into the header compartment. The differential in pressure between the header compartment and the ambient atmosphere will further cause the heated air to continue to flow through the holes or perforations that form the tear lines 28, which flow is indicated by double-headed arrow C in FIG. 2).

In accordance with a first variant of the first embodiment (for purposes of discussing the first variant, vent hole 32 in FIGS. 1 and 2 can be disregarded), a vent hole 30 is provided in the portion of front wall 12 that extends from the peel seal 20 to the permanent seal 22. Referring again to FIG. 2, heated air escaping from the product compartment 3 upon rupture of peel seal 20 will flow through vent hole 30 (which flow is indicated by arrow A) and into the ambient atmosphere. More than one such vent hole 30 can be provided in front wall 12.

In accordance with a second variant of the first embodiment (for purposes of discussing the second variant, vent holes 30 and 32 in FIGS. 1 and 2 can be disregarded), the permanent seal 22 may have one or more discontinuities (not shown). Each gap in permanent seal 22 acts as a respective vent hole that allows heated air escaping from the product compartment 3 upon rupture of peel seal 20 to flow into the header compartment 5. One such vent hole would be sufficient. The flow of heated air through an intermittent permanent seal 22 is indicated by arrow D in FIG. 2. The heated air in the header compartment can then exit the package via the holes or perforations that form tear lines 28, as previously described.

Peel seal is designed to rupture before any other portion of the structure forming product compartment 3 ruptures during cooking of the food product. Means are provided for venting the heated air from the interior volume of the package to the ambient atmosphere during cooking. After cooking, the consumer can access the cooked food product by tearing off the top seam 26, disengaging the closure profiles 6 and 8 from each other and then severing a tear line 34 formed in and disposed at the cusp of the barrier web 10. The tear line 34 may comprise a line of weakened tear resistance formed by laser scoring. Alternatively, tear line 34 may comprise a line of perforations capped by a sealing stripe (not shown in FIGS. 1 and 2)), as taught in U.S. Pat. No. 5,063,639. The sealing stripe may be heat sealed to the barrier web 10 in a band-shaped zone that extends on both sides of the perforated line 34. The sealing stripe effectively hermetically seals the perforations while still leaving the line of weakened tear resistance provided by the perforations.

A second embodiment of the invention is shown in FIG. 3. In this embodiment, the package comprises: front and rear walls 12 and 14 of a receptacle 2 (made, e.g., of bag making film); a base web 38 joined to the front wall 12 at a band-shaped zone of joinder 22 that extends the full width of the package; a barrier web 40 joined to the rear wall 14 at a band-shaped zone of joinder 24 that extends the full width of the package; a male closure profile 6 connected to and projecting from one side of the base web 38, and a female closure profile 8 connected to and projecting from one side of the barrier web 40. The zones of joinder 22 and 24 form permanent seals that are designed to remain intact and not rupture when the package with food product inside is exposed to a medium (e.g., air or water) heated to cooking temperatures. Again the male and female closure profiles form a fastener. The front and rear walls 12 and 14, the base web 38 and the portion of the barrier web 40 extending upward from the permanent seal 24 form a receptacle construction that is closed by the fastener.

As shown in FIG. 3, the length of the barrier web 40 (as seen in cross section) is greater than the length of the base web 38. A portion of the barrier web 40 is folded, that folded portion then being joined to the base web 38 by means of a peel seal 20. At the sides of the package, the opposing ends of the base web 38 and barrier web 40 are sealed to each other and captured within side seams (not shown) of the receptacle. Also the ends of the closure profiles are thermally crushed and joined together at the side seams.

The peel seal 20 extends the full width of the package. One side of the peel seal 20 is joined to the base web 38, while the other side of the peel seal 20 is joined to the folded extension of the barrier web 40. The interior volume of the receptacle construction is partitioned into two compartments 3 and 7 by the portion of barrier web 40 that extends from the peel seal 20 to the permanent seal 24. The compartment 7 is not hermetically sealed. Food product (not depicted in FIG. 3) is contained in the product compartment 3. So long as the peel seal 20 remains intact, the peel seal 20, permanent seal 24 and connecting portion of the barrier web 40 form a structure that hermetically seals the product compartment 3. Again, the peel seal 20 is designed to rupture when the pressure inside the product compartment reaches a predetermined level greater than ambient pressure but less than the pressure at which any other portion of the package would rupture. The attachment of the peel seal to a portion of the barrier web 40 that curls around places the forces on the peel seal in a peel mode as opposed to a tension mode, i.e., as the product compartment inflates, the webs joined to the peel seal apply peeling forces.

The compartment 7 communicates with the product compartment 3 via the rupture in the peel seal 20 and communicates with the ambient atmosphere via one or more vent holes. FIG. 3 depicts two alternate locations for a vent hole: vent hole 32 formed in the base web 38 or vent hole 36 formed in the male closure profile. In accordance with further alternatives, vent holes could be formed in the female closure profile or in the portion of the barrier web that forms part of the receptacle. Again the vent hole (or holes) allows the escape of heated air from inside the package following peel seal rupture. To summarize the path followed by heated air initially inside the product compartment, that air flows through the rupture in peel 20, into compartment 7, through the vent hole 32 or 36, and into the ambient atmosphere.

During cooking, only a portion of the peel seal 20, which in the embodiment of FIG. 3 extends the full width of the package, is ruptured. Therefore, after cooking, in order to access the cooked food product inside the product compartment 3, the consumer, in addition to disengaging the closure profiles 6 and 8, must also rupture the remainder of the peel seal 20.

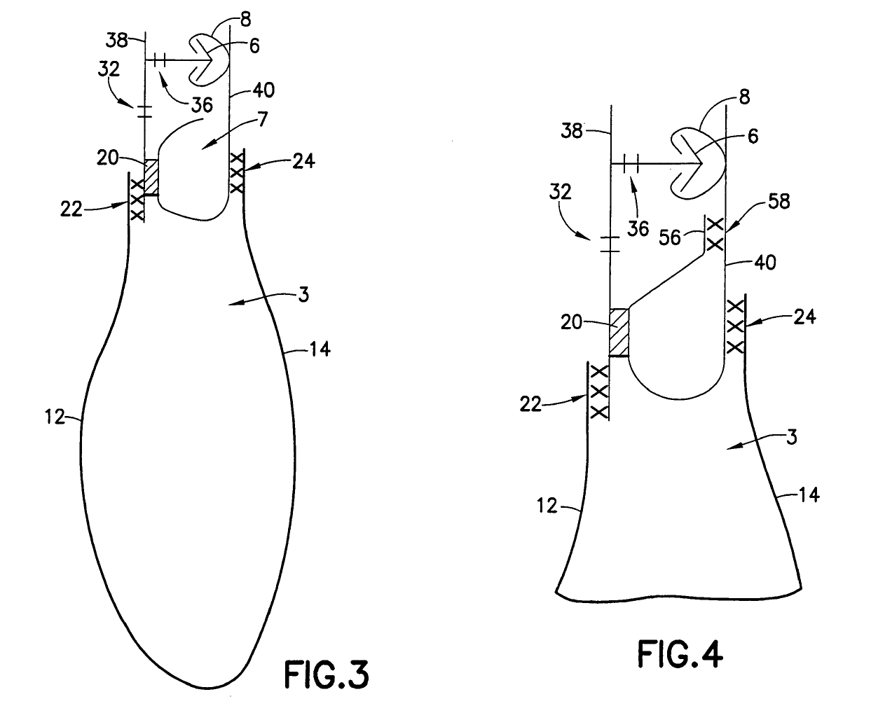

To facilitate rupturing the remainder of the peel seal 20, the second embodiment may be modified as shown in FIG. 4. The construction shown in FIG. 4 differs from that shown in FIG. 3 in that the distal portion 56 of the barrier web 40 has been heat sealed to an intermediate portion of the barrier web 40, as indicated by the permanent seal 58. This eliminates the need for the consumer to grasp the distal portion of the barrier web. Instead the consumer can simply pry the base web 38 and the folded portion of the barrier web 40 apart to access the product compartment 3.

The person skilled in the art will readily appreciate, in view of the teaching of FIG. 1, that the front and rear walls 12 and 14 in the embodiments shown in FIGS. 3 and 4 can be extended upward and sealed at the top to form a header, in which case small holes or micro-perforations (forming tear lines of the type indicated by numeral 28 in FIG. 1) will be provided in the front and rear walls directly below the top seam.

In the embodiments shown in FIGS. 1 and 3, a portion or portions of the barrier web also serve as a fastener base web or webs that support a closure profile or profiles. Embodiments in which the barrier web comprises a panel or strip separate from the fastener base webs will now be described with reference to FIGS. 5-8.

FIG. 5 shows a package comprising: front and rear walls 12 and 14 (made, e.g., of bag making film); a base web 38 joined to the front wall 12 at a band-shaped zone of joinder 22 that extends the full width of the package; a base web 42 joined to the rear wall 14 at a band-shaped zone of joinder 24 that extends the full width of the package; a male closure profile 6 connected to and projecting from one side of the base web 38, and a female closure profile 8 connected to and projecting from one side of the base web 42. The zones of joinder 22 and 24 form permanent seals that are designed to remain intact and not rupture when the package with food product inside is exposed to a medium (e.g., air or water) heated to cooking temperatures. Again the male and female closure profiles form a fastener. The front and rear walls 12 and 14 and the base webs 38 and 42 form a receptacle construction that is closed by the fastener.

As shown in FIG. 5, the package further comprises a barrier web 44 having a first portion joined to the base web 38 by means of a peel seal 20 and having a second portion joined to the rear wall 14 by means of a permanent seal 46. [Alternatively, the barrier web could be joined to the base web 42 by means of a peel seal and to the front wall 12 by means of a permanent seal.] The barrier web 44 extends the full width of the package, as do the peel seal 20 and the permanent seal 46. At the sides of the package, the opposing ends of the base webs 38 and 42 and the barrier web 44 are sealed to each other and captured within side seams (not shown) of the receptacle. Also the ends of the closure profiles are thermally crushed and joined together at the side seams.

The peel seal is designed to operate in the same manner as previously described with respect to other embodiments. One side of the peel seal 20 is joined to the base web 38, while the other side of the peel seal 20 is joined to the barrier web 44. The interior volume of the receptacle construction is partitioned into two compartments 3 and 7 by the barrier web 44. The compartment 7 is not hermetically sealed. Food product (not depicted in FIG. 5) is contained in the product compartment 3. So long as the peel seal 20 remains intact, the peel seal 20, permanent seal 46 and barrier web 44 form a structure that hermetically seals the product compartment 3. Again, the peel seal 20 is designed to rupture when the pressure inside the product compartment reaches a predetermined level greater than ambient pressure but less than the pressure at which any other portion of the package would rupture.

The compartment 7 communicates with the product compartment 3 via the rupture in the peel seal 20 and communicates with the ambient atmosphere via one or more vent holes. FIG. 5 depicts two alternate locations for a vent hole: vent hole 32 formed in the base web 38 or vent hole 36 formed in the male closure profile. In accordance with further alternatives, vent holes could be formed in the female closure profile 8 or in the base web 42. Again the vent hole (or holes) allows the escape of heated air from compartment 7 following the rupture of peel seal 20.

To facilitate the consumer gaining access to the product compartment after cooking, the distal portion of the barrier web 44 could be joined to the base web 42 by a permanent seal in a manner similar to that previously described with respect to FIG. 4.

The front and rear walls 12 and 14 in the embodiment shown in FIG. 5 can be extended upward and sealed at the top to form a header, in which case small holes or micro-perforations (forming tear lines of the type indicated by numeral 28 in FIG. 1) will be provided in the front and rear walls directly below the top seam.

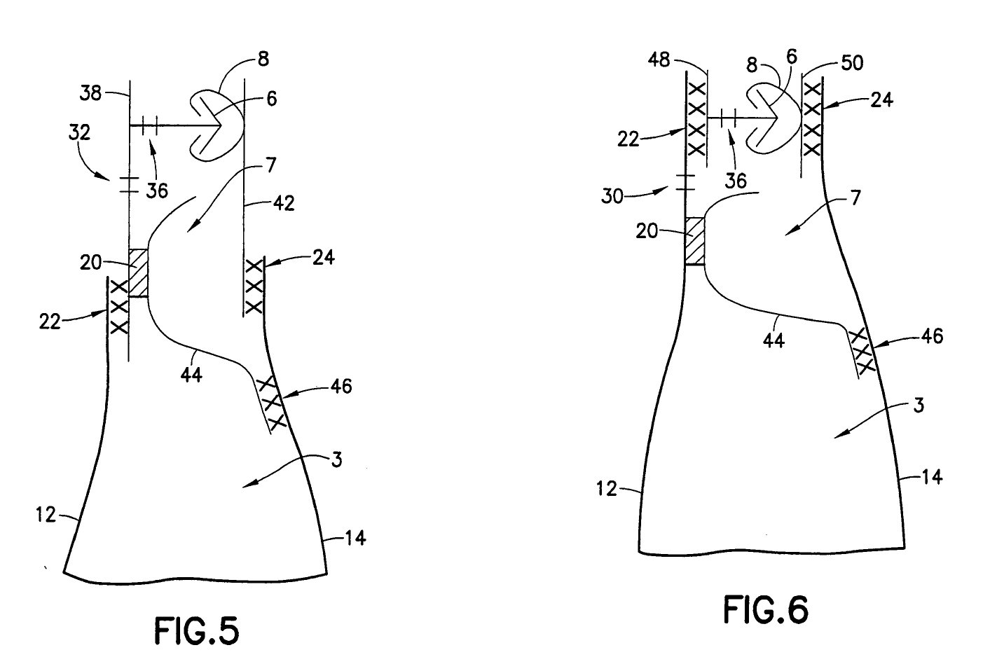

FIG. 6 shows a package comprising: front and rear walls 12 and 14 (made, e.g., of bag making film); a base web 48 joined to the front wall 12 at a band-shaped zone of joinder 22 that extends the full width of the package; a base web 50 joined to the rear wall 14 at a band-shaped zone of joinder 24 that extends the full width of the package; a male closure profile 6-connected to and projecting from one side of the base web 48, and a female closure profile 8 connected to and projecting from one side of the base web 50. The zones of joinder 22 and 24 form permanent seals that are designed to remain intact and not rupture when the package with food product inside is exposed to a medium (e.g., air or water) heated to cooking temperatures. Again the male and female closure profiles form a fastener. The front and rear walls 12 and 14 form a receptacle construction that is closed by the interlocked closure profiles. A so-called “string zipper”, comprising flangeless zipper strips, can be employed, respective marginal portions of the front and rear walls 12 and 14 being joined to the backs of the respective zipper strips.

As shown in FIG. 6, the package further comprises a barrier web 44 having a first portion joined to the front wall 12 by means of a peel seal 20 and having a second portion joined to the rear wall 14 by means of a permanent seal 46. [Alternatively, the barrier web could be joined to the rear wall 14 by means of a peel seal and to the front wall 12 by means of a permanent seal.] Again, the barrier web 44 extends the full width of the package, as do the peel seal 20 and the permanent seal 46. At the sides of the package, the opposing ends of the base webs 38 and 42 are sealed to each other and captured within side seams (not shown) of the receptacle. Also the ends of the closure profiles are thermally crushed and joined together at the side seams. Likewise the opposing ends of the barrier web 44 are captured within the side seams of the receptacle.

The interior volume of the receptacle construction is partitioned into two compartments 3 and 7 by the barrier web 44. The intact peel seal 20, permanent seal 46 and barrier web 44 form a structure that hermetically seals the product compartment 3. The compartment 7 communicates with the product compartment 3 via a rupture in the peel seal 20 and communicates with the ambient atmosphere via one or more vent holes. FIG. 6 depicts two alternate locations for a vent hole: vent hole 30 formed in the front wall 12 (above the peel seal 20 and below the permanent seal 22) or vent hole 36 formed in the male closure profile. In accordance with further alternatives, vent holes could be formed in the female closure profile 8 or in the rear wall 14. Again the vent hole (or holes) allows the escape of heated air from compartment 7 following the rupture of peel seal 20.

For the variants of the FIG. 6 embodiment in which the vent hole (or holes) is provided in one of the closure profiles and not in the front or rear wall, the front and rear walls 12 and 14 can be extended upward and sealed at the top to form a header. In that case, small holes or micro-perforations (forming tear lines of the type indicated by numeral 28 in FIG. 1) will be provided in the front and rear walls directly below the top seam.

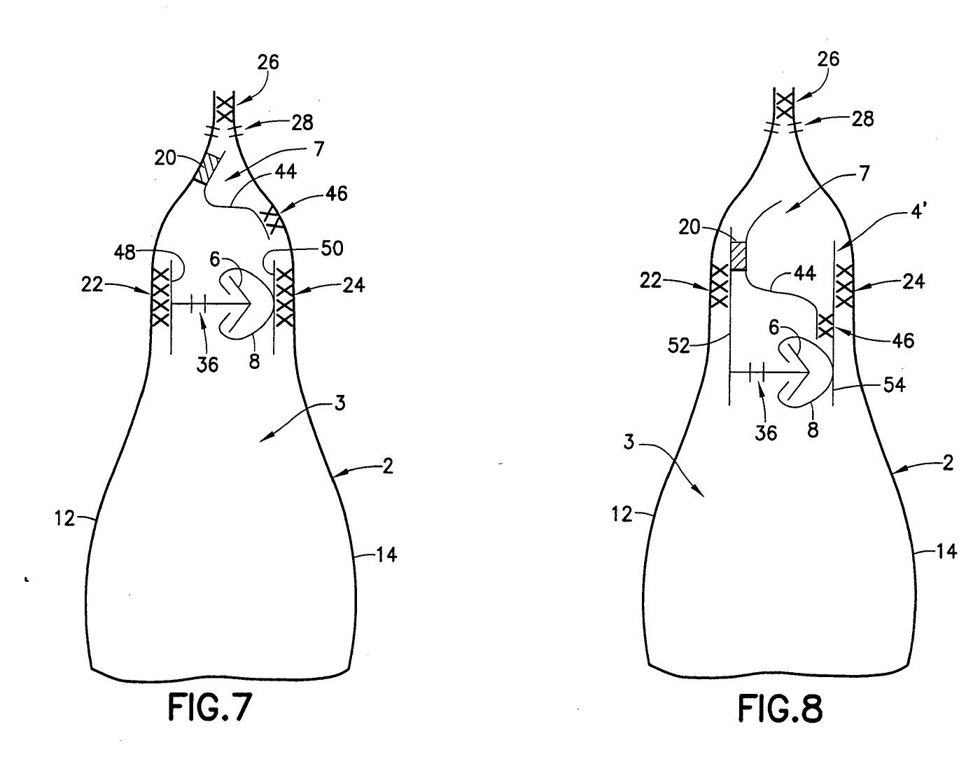

The embodiment shown in FIG. 7 differs from that shown in FIG. 6 in that the front and rear walls are extended upward to form a header (as described in the previous paragraph) and the peel seal 20 and barrier web 44 are disposed above the closure profiles. One side of the peel seal 20 is joined to the front wall 12, while the other side is joined to one portion of the barrier web 44. Another portion of the barrier web 44 is joined to the rear wall by a permanent seal 46. [Alternatively, the peel seal could be attached to the rear wall and the barrier web to the front wall.] The interior volume of the receptacle 2 is partitioned into two compartments 3 and 7 by the barrier web 44, with the fastener being disposed inside the product compartment. The intact peel seal 20, permanent seal 46 and barrier web 44 form a structure that hermetically seals the product compartment 3. The header compartment 7 communicates with the portion of the product compartment 3 disposed above the fastener via a rupture in the peel seal 20 and communicates with the ambient atmosphere via the vent holes that form the tear lines 28, as previously described. The portion of the hermetically sealed product compartment disposed above the fastener communicates with the portion of the hermetically sealed product compartment disposed below the fastener via one or more vent holes formed in either or both of the closure profiles. FIG. 7 shows a vent hole 36 formed in the male closure profile 6.

A reclosable package in accordance with yet another embodiment of the invention is shown in cross section in FIG. 8. The package comprises a receptacle 2 and a flexible plastic structure 4′ (described in detail later) disposed inside the receptacle. The receptacle 2 comprises a front wall 12 and a rear wall 14 which are sealed together at parallel side edges (not shown in FIG. 8) and are integrally connected by a fold line at the bottom of the receptacle. In an alternative embodiment, the front and rear walls could be sealed together along the sides and the bottom. The top marginal portions of the front and rear walls 12 and 14 are joined together to form a top seam 26. Immediately below the top seam 26, the front and rear walls have respective tear lines 28 that facilitate removal of the top seam 26 by tearing along those lines. Each tear line 28 comprises a respective series of small holes or micro-perforations that also serve as vent holes, as previously described.

In the embodiment shown in FIG. 8, the internal structure 4′ comprises: a base web 52 joined to the front wall 12 at a band-shaped zone of joinder 22 that extends the full width of the package; a base web 54 joined to the rear wall 14 at a band-shaped zone of joinder 24 that extends the full width of the package; a male closure profile 6 connected to and projecting from one side of the base web 52; a female closure profile 8 connected to and projecting from one side of the base web 54; a barrier web 44 joined to the base web 54 at a band-shaped zone of joinder 46 that extends the full width of the package; and a peel seal 20 joined on one side to the base web 52 and on the other side to the barrier web. [Alternatively, the peel seal could be attached to base web 54 and the barrier web to base web 52.] The zones of joinder 22, 24 and 46 form permanent seals that are designed to remain intact and not rupture during cooking. At the sides of the package, the opposing ends of the barrier web 44 are sealed to each other and captured within side seams (not shown) of the receptacle.

The interior volume of the receptacle 2 is partitioned into two compartments 3 and 7 by the barrier web 44, with the fastener being disposed inside the product compartment. So long as the peel seal 20 remains intact, the peel seal 20, permanent seal 46 and barrier web 44 form a structure that hermetically seals the product compartment 3. The header compartment 7 communicates with the portion of the product compartment 3 disposed above the fastener when the peel seal 20 ruptures and communicates with the ambient atmosphere via the vent holes that form the tear lines 28, as previously described, before and after peel seal rupture. The portion of the hermetically sealed product compartment disposed above the fastener communicates with the portion of the hermetically sealed product compartment disposed below the fastener via one or more vent holes formed in either or both of the closure profiles. FIG. 8 shows a vent hole 36 formed in the male closure profile 6. Alternatively, a vent hole could be provided in base web 52 (or in base web 54 if the peel seal is attached to base web 54 and the barrier web 44 is attached to base web 52).

In each of the embodiments shown in FIGS. 3 and 5-8, a frangible barrier web could be utilized while eliminating the peel seal. In each instance, a frangible panel would be joined by permanent seals to the front and back of the receptacle construction and also captured in the side seams to form a barrier that hermetically seals the product compartment. The frangible panel must be designed to rupture before any of the other containment seals rupture. For example, a web material could be treated or processed to have an area or line of weakness designed to fail when the pressure inside the product compartment reaches a level that would be produced during cooking.

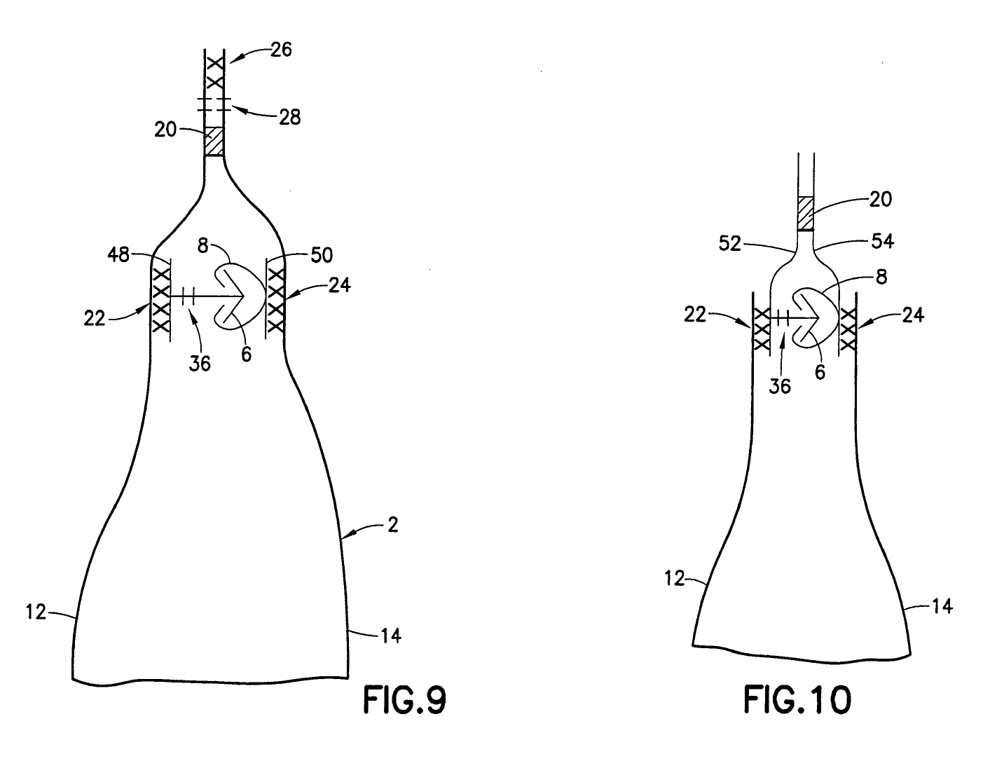

The embodiments shown in FIGS. 9-11 have product compartments hermetically sealed without the employment of a barrier web. The embodiment shown in FIG. 9 differs from that shown in FIG. 7 in that the barrier web has been eliminated and instead, the peel seal 20 is joined to opposing portions of the front and rear walls 12 and 14 on the consumer side of the fastener. As the product compartment inflates during cooking, heated air flows through vent hole 36 in the male closure profile (or vent holes in the female closure profile or vent holes in both) and into the interior space between the peel seal 20 and the closure profiles. [Alternatively, a short section of the fastener could be left open.] This equalizes the pressure above and below the fastener. When the pressure inside the product compartment reaches a certain level, the peel seal 20 ruptures and heated air then vents out the holes or perforations of the tear lines 28.

A further embodiment is shown in FIG. 10. This package comprises front and rear walls 12 and 14, fastener base webs 52 and 54 joined to respective marginal portions of the front and rear walls at permanent seals 22 and 24, and a peel seal 20 joined to opposing portions of the base webs 52 and 54 that extend upward from the zones of joinder. These extended portions serve as pull flanges for opening the closure profiles 6 and 8. Again, one or more vent holes formed in the closure profiles provide a means for equalizing the pressure in the spaces above and below the closure profiles. The peel seal 20 is designed to rupture when the pressure inside the product compartment reaches a certain level during cooking. Heated air inside the package can then vent directly to the ambient atmosphere via the rupture in the peel seal 20.

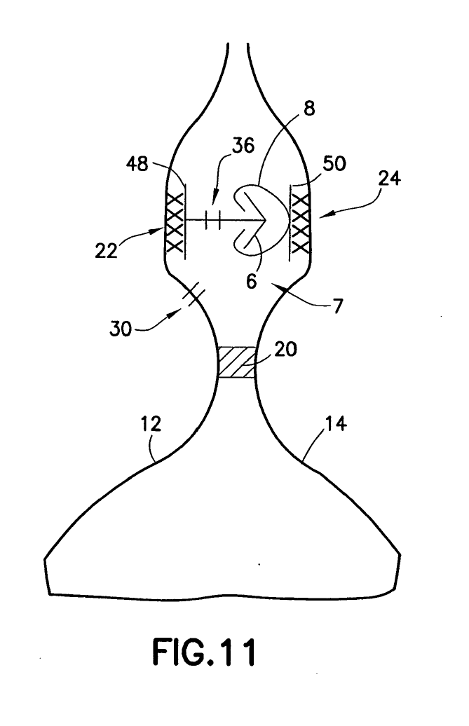

Yet another embodiment is shown in FIG. 11. In this case the peel seal 20 is joined to opposing portions of the front and rear walls 12 and 14 on the product side of the fastener. When the pressure inside the product compartment reaches a certain level, the peel seal 20 ruptures and heated air then enters compartment 7, bounded by the peel seal 20 and the fastener, and vents out of compartment 7 via one or more holes 36 formed in the male closure profile (or vent holes in the female closure profile or vent holes in both) and into the ambient atmosphere. Alternatively, instead of providing one or more vent holes in the fastener, one or more vent holes 30 can be provided in wall 12 (or wall 14). The compartment 7 communicates with the product compartment via the rupture in the peel seal 20 and communicates with the ambient atmosphere via the vent hole(s) 30. Again, it should be appreciated that, although the vent holes 30 and 36 are both shown in FIG. 11, they are preferably in the alternative (although to provide both concurrently is within the scope of the invention).

In accordance with a variation of the embodiment shown in FIG. 11, the tops of the receptacle walls may be joined to form a top seam similar to item 26 in FIG. 9, with small holes or micro-perforations (forming tear lines of the type indicated by numeral 28 in FIG. 9) provided in the front and rear walls directly below the top seam. In the latter case, heated air will flow through the rupture in the peel seal, through the vent hole(s) in the fastener and through the perforated tear lines during cooking.

As an alternative to venting air through holes or perforations that form tear lines, air could be vented through a gap or gaps in the top seal, in which case the tear lines could be formed by laser scoring or other means that do not involve making perforations or holes.

Furthermore, for those embodiments in which heated air needs to be vented through interlocked closure profiles, instead of making vent holes in the closure profiles, the closure profiles could be distorted or deformed to provide gaps through which heated and pressurized air can flow. Alternatively, a section of the fastener could be left open by disengaging the closure profiles from each other.

The peel seal must be designed to peel apart or rupture when the pressure inside the product compartment reaches a certain level. One known method of making a peel seal involves the application of respective laminates on opposing portions of the receptacle or closure, which laminates extend the full width of the mouth of the receptacle. A peel seal is formed by heat sealing the peel sealable laminates together. Later, when the consumer pulls the opposing portions of the receptacle or closure apart, the peel seal will rupture. During rupture of the peel seal, one or more layers of one laminate disengages from the other layer or layers of that laminate and remain adhered to the other laminate. As a result, the other laminate will include at least one additional layer after the peel seal has been broken. The disengagement of the one layer from the first laminate is accomplished by using layers composed of different polymeric materials, with the resulting adjacent layers having varying bond strengths between the layers. The rupture will occur between the two layers of the peel seal that have the lowest bond strength.

Another known method of making a peel seal involves adhering a respective layer of film to opposing portions of the receptacle or closure, which film layers extend the full width of the mouth of the receptacle, wherein one or both of the film layers contains contaminants. When the peel seal is formed by heat sealing the film layers together, the bond between them is weak due to the surface contamination. The film layers detach from each other during rupture of the peel seal.

One known composition of a heat-sealable peel seal material consists of ethylene vinyl acetate copolymer, polyethylene-based wax and polypropylene. Another known composition is a blend of polybutylene and low-density polyethylene. Many other peel seal compositions are known. For example, peel seals can be created using a variety of known pressure-sensitive adhesives.

While the invention has been described with reference to preferred embodiments, it will be understood by those skilled in the art that various changes may be made and equivalents may be substituted for members thereof without departing from the scope of the invention. In addition, many modifications may be made to adapt a particular situation to the teachings of the invention without departing from the essential scope thereof. Therefore it is intended that the invention not be limited to the particular embodiment disclosed as the best mode contemplated for carrying out this invention, but that the invention will include all embodiments falling within the scope of the appended claims.

As used in the claims, the verb “joined” means fused, bonded, sealed, or adhered, whether by application of heat and/or pressure, application of ultrasonic energy, application of a layer of adhesive material or bonding agent, interposition of an adhesive or bonding strip, etc. As used in the claims, the term “wall” is used in a broad sense to include both a discrete piece of packaging material and a portion of a folded piece of packaging material. As used in the claims, the term “receptacle construction” should not be limited to a structure consisting of “walls” (as defined in the preceding sentence), but rather should be given a broader construction that also encompasses a structure comprising those portions of “walls” and fastener base webs that bound the interior volume of a package.

1. A package comprising:
means for forming a first interior volume that is hermetically sealed, at least a portion of said first interior volume containing product;
means for forming a second interior volume that is in fluid communication with the exterior of said package via a vent hole and is not in fluid communication with said first interior volume; and
frangible means designed to rupture when the pressure inside said first interior volume increases to a predetermined level during cooking, said second interior volume being in fluid communication with said first interior volume as a result of said rupture of said frangible means.

2. The package as recited in claim 1, wherein said frangible means comprises a peel seal designed to rupture when said predetermined pressure level is reached inside said first interior volume.

3. The package as recited in claim 1, wherein said frangible means comprises a panel designed to rupture when said predetermined pressure level is reached inside said first interior volume.

4. A package comprising:
a receptacle construction having surfaces that bound an interior volume;
a fastener comprising first and second closure profiles that are mutually interengageable and disposed within said interior volume;
a peel seal joined to said receptacle construction;
a barrier web-comprising a first portion that hermetically seals a first portion of said interior volume of said receptacle construction, said barrier web comprising a second portion joined to one side of said peel seal and connected to said first portion of said barrier web;
food product contained in said hermetically sealed first portion of said interior volume of said receptacle construction; and
a first vent hole that allows fluid communication between a second portion of said interior volume of said receptacle construction not hermetically sealed by said barrier and the exterior of said package,
wherein said peel seal is designed to rupture when the pressure inside said first portion of said interior volume increases to a predetermined level during cooking, said second portion of said interior volume being in fluid communication with said first portion of interior volume as a result of said rupture of said peel seal.

5. The package as recited in claim 4, wherein said peel seal is joined to said receptacle construction along a band-shaped zone that extends the full width of said receptacle construction.

6. The package as recited in claim 4, wherein
said first and second closure profiles are connected to said barrier web;
said receptacle construction comprises first and second walls joined at a top seal, the other side of said peel seal being joined to said first wall; and
said barrier web comprises a third portion joined to said first wall and a fourth portion joined to said second wall, said first portion of said barrier web being connected to said second and fourth portions of said barrier web.

7. The package as recited in claim 6, wherein said first vent hole is disposed in a portion of said first wall that is disposed between said peel seal and said third portion of said barrier web.

8. The package as recited in claim 6, wherein there is a gap in the zone of joinder of said first wall to said third portion of said barrier web.

9. The package as recited in claim 6, wherein said barrier web has a second vent hole at a location above said first closure profile and below said third portion of said barrier web.

10. The package as recited in claim 6, wherein said first vent hole is located at an elevation higher than the elevation of said third and fourth portions of said barrier web.

11. The package as recited in claim 4, wherein said receptacle construction comprises first and second walls, a base web having a first portion joined to said first wall, and third, fourth and fifth portions of said barrier web, said third portion of said barrier web being joined to said second wall and connected to said first and fourth portions of said barrier web, and said fifth portion of said barrier web being connected to said fourth portion of said barrier web, said first closure profile being connected to said base web, and said second closure profile being connected to said fifth portion of said barrier web.

12. The package as recited in claim 11, wherein said barrier web has a length when viewed in cross section that is greater than the length of said base web when viewed in cross section, said second portion of said barrier web being joined to one side of said peel seal, the other side of said peel seal being joined to a second portion of said base web.

13. The package as recited in claim 12, wherein said first vent hole is disposed in a third portion of said base web disposed between said second portion of said base web and said first closure profile or in one of said first or second closure profiles.

14. The package as recited in claim 13, wherein a sixth portion of said barrier web is connected to said second portion of said barrier web and is joined to said fourth portion of said barrier web.

15. The package as recited in claim 12, wherein said first vent hole is disposed in said fourth portion of said barrier web.

16. The package as recited in claim 4, wherein said receptacle construction comprises first and second walls, a first base web joined to said first wall, and a second base web joined to said second wall, said first closure profile being connected to said first base web, and said second closure profile being connected to said second base web, wherein said peel seal is joined to said first wall or to said first base web, and a third portion of said barrier web is connected to said second portion of said barrier web and joined to said second wall or to said second base web.

17. The package as recited in claim 16, wherein said first and second closure profiles are disposed outside of said first portion of said interior volume of said receptacle construction.

18. The package as recited in claim 16, wherein said first and second closure profiles are disposed within said first portion of said interior volume of said receptacle construction.

19. The package as recited in claim 18, wherein a second vent hole is formed in one of said first and second closure profiles or in one of said first and second base webs.

20. A package comprising:
a receptacle construction having surfaces that bound an interior volume;
a peel seal joined to said receptacle construction in a manner that hermetically seals a portion of said interior volume, said peel seal being designed to burst when the pressure inside said hermetically sealed portion of said interior volume reaches a predetermined level during cooking;
a fastener comprising first and second closure profiles that are mutually interengageable and disposed within said interior volume, said fastener comprising a vent hole that allows fluid communication between a first portion of said interior volume disposed below said fastener and a second portion of said interior volume disposed above said fastener; and
food product contained within said second portion of said interior volume.

21. The package as recited in claim 20, wherein said peel seal is disposed within said first portion of said interior volume.

22. The package as recited in claim 20, wherein said peel seal is disposed within said second portion of said interior volume.
